(19) United States
(12) Patent Application Publication
(10) Pub. No.: US 2018/0336992 A1
(43) Pub. Date: Nov. 22, 2018

(54) MAGNETIC BEAD-BASED FILTER DEVICE

(71) Applicant: Tecstar Technology Co., Ltd., Taoyuan City (TW)

(72) Inventor: Wei-Chin HSUEH, Taoyuan City (TW)

(21) Appl. No.: 15/600,550

(22) Filed: May 19, 2017

(51) Int. Cl. H01F 27/26; H01F 27/28; H01F 27/33

(52) U.S. Cl. CPC H01F 27/263; H01F 27/33; H01F 27/2823

(57) ABSTRACT

A magnetic bead-based filter device includes an iron core made by compression molding or die casting and including two position-limiting end blocks, a plurality of iron core columns connected between the position-limiting end blocks and arranged in a row, an insertion space defined between each two adjacent iron core columns and a positioning space defined around an outer side of each of the two iron core columns at the two opposite lateral sides, and an enameled wire inserted through the insertion space between each two adjacent iron core columns and wound around each positioning space to form a continuous series of windings around each iron core column.

### BACKGROUND OF THE INVENTION

### 1. Field of the Invention

The present invention relates to filter device technology for removing noises, and more particularly to a magnetic bead-based filter device, which includes an iron core having two position-limiting end blocks and a plurality of iron core columns connected between the position-limiting end blocks, and an enameled wire inserted through the insertion space between each two adjacent iron core columns and wound around each positioning space around an outer side of each of the two iron core columns at the two opposite lateral sides to form a continuous winding around each iron core column.

### 2. Description of the Related Art

Regular magnetic bead-based filter devices for removing noises are commonly comprised of an iron core and an enameled wire wound around each iron core column of the iron core to form a continuous series of windings. However, the procedure of winding the enameled wire around each iron core column is complicated and difficult to achieve, resulting in time and labor consuming and low product yield. Further, when winding the enameled wire around the iron core columns of the iron core, the enameled wire cannot be fixed to the iron core columns, thus, the multiple windings are easily peeled off and the integrity of the winding arrangement is lost. Therefore, the magnetic beads must be fixed with the iron core columns of the iron core with an adhesive, thereby increasing the manufacturing cost.

### SUMMARY OF THE INVENTION

The present invention has been accomplished under the circumstances in view. It is therefore the main object of the present invention to provide a magnetic bead-based filter device, which has the characteristics of ease of fabrication, high yield rate and low manufacturing cost.

To achieve this and other objects of the present invention, a magnetic bead-based filter device comprises an iron core and an enameled wire. The iron core comprises two opposing position-limiting end blocks and an iron core column unit. The iron core column unit comprises a first iron core column and a second iron core column, an insertion space defined between the first iron core column and the second iron core column, and a positioning space defined around an outer side of each of the first and second iron core columns. The enameled wire comprises a body segment, a first positioning segment and a second positioning segment. The body segment has a straight shape. The first and second positioning segments are L-shaped. The first and second positioning segments are respectively extended from two opposite ends of the body segment. The body segment is inserted through the insertion space. The first positioning segment is wound around one positioning space at the outer side of the first iron core column. The second positioning segment is wound around the other positioning space at the outer side of the second iron core column. Thus, the enameled wire forms a continuous series of windings around each of the first and second iron core columns and fixed in the inside of the iron core.

To achieve this and other objects of the present invention, a magnetic bead-based filter device comprises an iron core and an enameled wire. The iron core comprises two opposing position-limiting end blocks and an iron core column unit. The iron core column unit comprises a first iron core column, a second iron core column and a third iron core column arranged in a row and equally spaced from one another. The second iron core column is equally spaced between the first iron core column and the third iron core column. The second iron core column defines with the first iron core column and the third iron core column a respective insertion space therebetween. The first iron core column and the third iron core column each define one respective positioning space around an outer side thereof. The enameled wire comprises a body segment, a first positioning segment and a second positioning segment. The body segment is [symbol] -shaped. The first positioning segment and the second positioning segment are L-shaped. The first positioning segment and the second positioning segment are respectively extended from two opposite ends of the body segment. The body segment has the two opposite ends thereof respectively inserted through the two insertion spaces at two opposite lateral sides of the second iron core column. The first positioning segment is wound around the positioning space at the outer side of the first iron core column. The second positioning segment is wound around the positioning space at the outer side of the third iron core column. Thus, the enameled wire forms a continuous series of windings around the first, second and third iron core columns and fixed in the inside of the iron core.

Preferably, the magnetic bead-based filter device further comprises a conductive glue bonded in between the two opposite ends of the enameled wire and the iron core to affix the enameled wire to the iron core.

### BRIEF DESCRIPTION OF THE DRAWINGS

FIG. 1 is an oblique top elevational view of an iron core of a magnetic bead-based filter device in accordance with a first embodiment of the present invention.

FIG. 2 is a sectional elevation of the iron core shown in FIG. 1.

FIG. 3 is a schematic drawing of the first embodiment of the present invention, illustrating the enameled wire wound round the iron core (I).

FIG. 4 is a schematic drawing of the first embodiment of the present invention, illustrating the enameled wire wound round the iron core (II).

FIG. 5 is a schematic drawing of the first embodiment of the present invention, illustrating the enameled wire wound round the iron core (III).

FIG. 6 is an oblique top elevational view of an iron core of a magnetic bead-based filter device in accordance with a second embodiment of the present invention.

FIG. 7 is a sectional elevation of the iron core shown in FIG. 6.

FIG. 8 is a schematic elevation of the second embodiment of the present invention, illustrating the enameled wire wound round the iron core.

### DETAILED DESCRIPTION OF THE PREFERRED EMBODIMENT

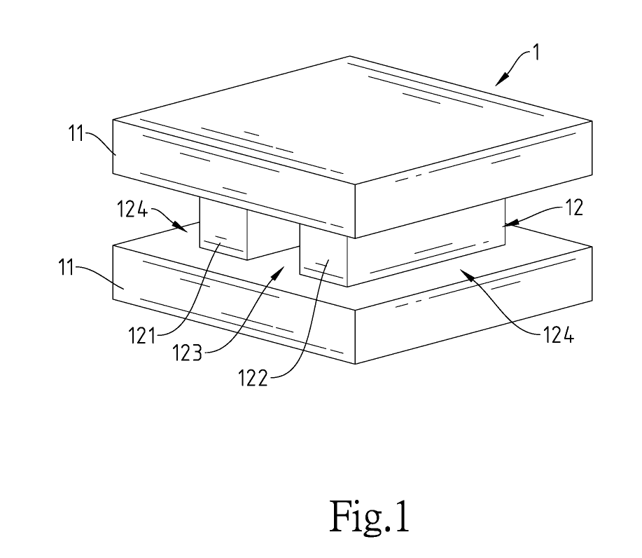

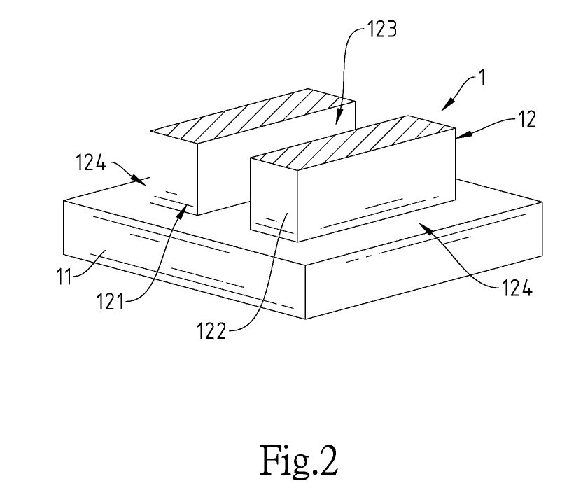

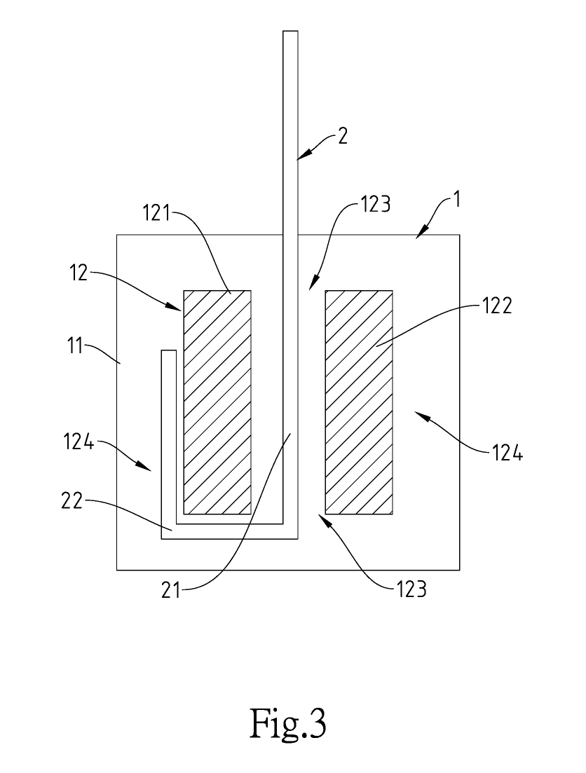

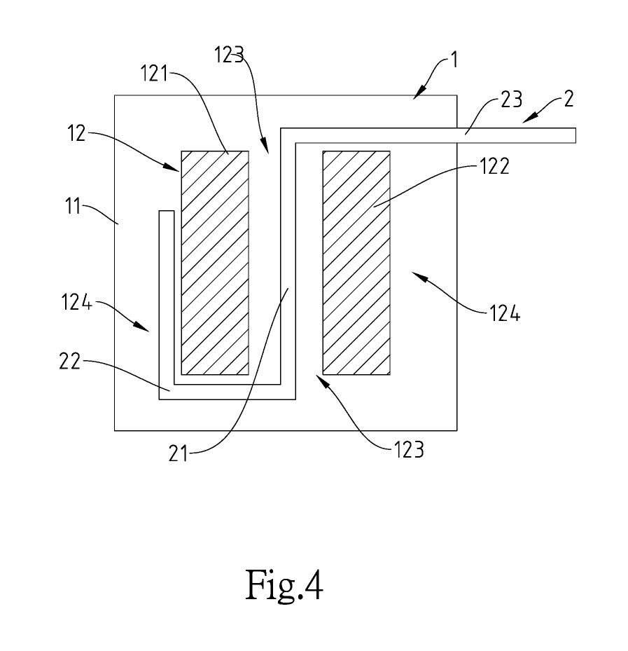

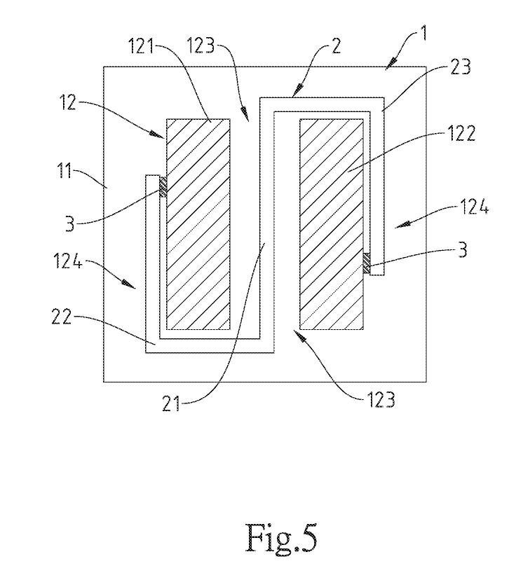

Referring to FIGS. 1-5, a magnetic bead-based filter device in accordance with a first embodiment of the present invention is shown. The magnetic bead-based filter device comprises an iron core 1 and an enameled wire 2.

The iron core 1 comprises two opposing position-limiting end blocks 11 and an iron core column unit 12. The iron core column unit 12 includes a first iron core column 121 and a second iron core column 122 respectively and fixedly connected between the two position-limiting end blocks 11 in such a manner that an insertion space 123 is defined between the first iron core column 121 and the second iron core column 122 and a positioning space 124 is defined around an outer side of each of the first iron core column 121 and second iron core column 122. Preferably, the position-limiting end blocks 11 and iron core column unit 12 of the iron core 1 are made in one piece using compression molding or die casting technology.

The enameled wire 2 comprises a body segment 21, a first positioning segment 22 and a second positioning segment 23. The body segment 21 is a straight segment. The first positioning segment 22 and the second positioning segment 23 are L-shaped. Further, the first positioning segment 22 and the second positioning segment 23 are respectively extended from two opposite ends of the body segment 21. Further, a conductive glue such as silver paste or tin solder is bonded in between the ends of the first positioning segment 22 and second positioning segment 23 and the body of the iron core 1 to affix the enameled wire 2 to the iron core 1. The body segment 21 is inserted into the insertion space 123 of the iron core 1. The first positioning segment 22 is mounted in the positioning space 124 around the outer side of the first iron core column 121 of the iron core 1. The second positioning segment 23 is mounted in the positioning space 124 around the outer side of the second iron core column 122 of the iron core 1.

The enameled wire 2 is inserted through the insertion space 123 of the iron core 1 and wound around the positioning spaces 124 of the iron core 1 to form a continuous series of windings around the first iron core column 121 and second iron core column 122 of the iron core 1, and is fixed in the interior of the iron core 1.

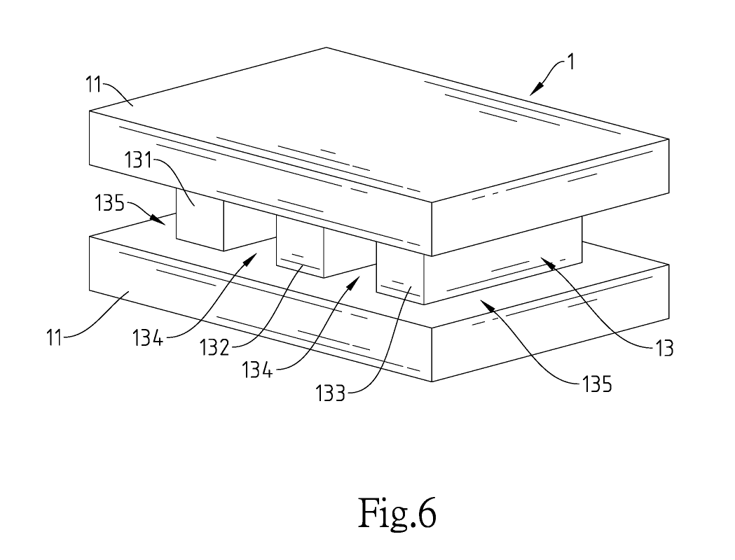

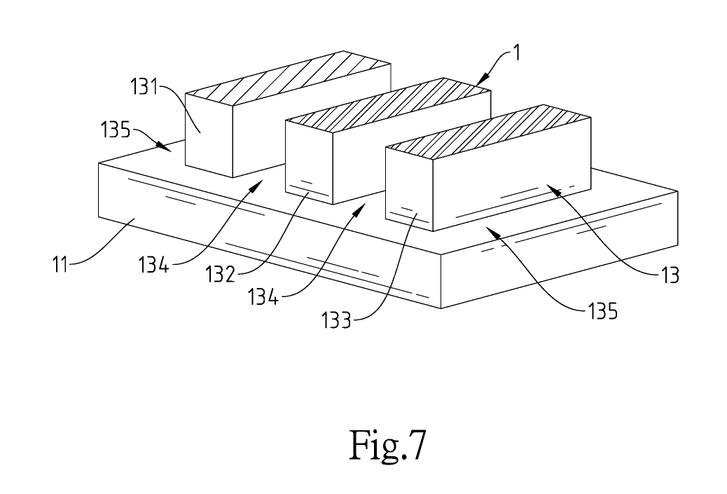

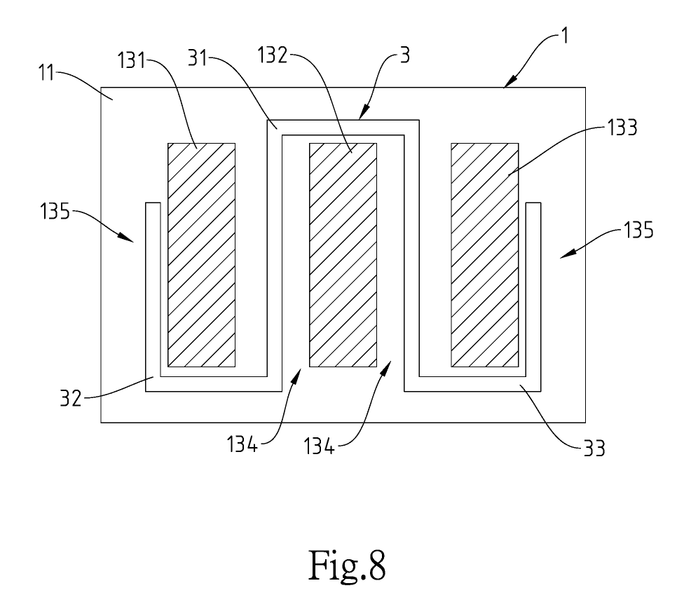

Referring to FIGS. 6-8, a magnetic bead-based filter device in accordance with a second embodiment of the present invention is shown. This second embodiment is substantially similar to the aforesaid first embodiment with the exception that the iron core column unit 13 of the iron core 1 comprises multiple iron core columns (131,132,133), and an enameled wire 3 wound around to form a continuous winding in the iron core 1.

The iron core 1 comprises two opposing position-limiting end blocks 11 and an iron core column unit 13. The iron core column unit 13 includes a first iron core column 131, a second iron core column 132 and a third iron core column 133 respectively and fixedly connected between the two position-limiting end blocks 11 in such a manner that the second iron core column 132 is equally spaced between the first iron core column 131 and the third iron core column 133; two insertion spaces 134 are respectively defined between the first iron core column 131 and the second iron core column 132 and between the second iron core column 132 and the third iron core column 134; a positioning space 135 is defined around an outer side of each of the first iron core column 131 and third iron core column 133. Preferably, the position-limiting end blocks 11 and iron core column unit 13 of the iron core 1 are made in one piece using compression molding or die casting technology.

The enameled wire 3 comprises a body segment 31, a first positioning segment 32, a second positioning segment 33. The body segment 31 is [symbol] -shaped. The first positioning segment 32 and the second positioning segment 33 are L-shaped. Further, the first positioning segment 32 and the second positioning segment 33 are respectively extended from two opposite ends of the body segment 31. Further, a conductive glue such as silver paste or tin solder is bonded in between the ends of the first positioning segment 32 and second positioning segment 33 and the body of the iron core 1 to affix the enameled wire 3 to the iron core 1. The body segment 31 has two opposite ends thereof respectively inserted through the two insertion spaces 123 of the iron core 1. The first positioning segment 32 is mounted in the positioning space 135 around the outer side of the first iron core column 131 of the iron core 1. The second positioning segment 33 is mounted in the positioning space 135 around the outer side of the third iron core column 133 of the iron core 1.

The enameled wire 2 is inserted through the insertion spaces 134 of the iron core 1 and wound around the positioning spaces 125 of the iron core 1 to form a continuous series of windings around the first iron core column 131, second iron core column 132 and third iron core column 133 of the iron core 1, and is fixed in the interior of the iron core 1.

Therefore, the key technology of the present invention capable of solving the drawbacks and problems of the prior art designs lies in that: the iron core column unit (12,13) between the position-limiting end blocks 11 of the iron core 1 comprises a plurality of iron core columns (121,122,131,132,133) equally spaced from one another at a predetermined gap so that the enameled wire (2,3) can be wound to form a continuous series of windings around the iron core columns (121,122,131,132,133) fixed in the interior of the iron core 1, providing the characteristics of ease of fabrication, high yield rate and low manufacturing cost.

What the invention claimed is:

1. A magnetic bead-based filter device, comprising an iron core and an enameled wire, wherein:
said iron core comprises two opposing position-limiting end blocks and an iron core column unit, said iron core column unit comprising a plurality of iron core columns fixedly connected between said two position-limiting end blocks, two of said iron core columns being disposed at two opposite lateral sides, an insertion space defined between each two adjacent said iron core columns, and a positioning space defined around an outer side of each of the said two iron core columns at the said two opposite lateral sides;
said enameled wire is inserted through each said insertion space and wound around each said positioning space of said iron core to form a continuous series of windings around each said iron core column and fixed in the inside of said iron core;
wherein said iron core column unit comprises a first iron core column and a second iron core column, a first insertion space defined between said first iron core column and said second iron core column, and the positioning spaces are defined around an outer side of each of said first iron core column and said second iron core column; and
said enameled wire comprises a body segment, a first positioning segment and a second positioning segment, said body segment having a straight shape, said first positioning segment and said second positioning segment being L-shaped, said first positioning segment and said second positioning segment being respectively extended from two opposite ends of said body segment, said body segment being inserted through said first insertion space, said first positioning segment being wound around one said positioning space at the outer side of said first iron core column, said second positioning segment being wound around the other said positioning space at the outer side of said second iron core column.

2. (canceled)

3. A magnetic bead-based filter device, comprising an iron core and an enameled wire, wherein:
said iron core comprises two opposing position-limiting end blocks and an iron core column unit, said iron core column unit comprising a plurality of iron core columns fixedly connected between said two position-limiting end blocks, two of said iron core columns being disposed at two opposite lateral sides, an insertion space defined between each two adjacent said iron core columns, and a positioning space defined around an outer side of each of the said two iron core columns at the said two opposite lateral sides;
said enameled wire is inserted through each said insertion space and wound around each said positioning space of said iron core to form a continuous series of windings around each said iron core column and fixed in the inside of said iron core;
wherein said iron core column unit comprises a first iron core column, a second iron core column and a third iron core column arranged in a row and equally spaced from one another, said second iron core column equally spaced between said first iron core column and said third iron core column, said second iron core column defining with said first iron core column and said third iron core column a respective insertion space therebetween, said first iron core column and said third iron core column each defining one respective said positioning space around an outer side thereof;
said enameled wire comprises a body segment, a first positioning segment and a second positioning segment, said body segment being n-shaped, said first positioning segment and said second positioning segment being L-shaped, said first positioning segment and said second positioning segment being respectively extended from two opposite ends of said body segment, said body segment having the two opposite ends thereof respectively inserted through the two said insertion spaces at two opposite lateral sides of said second iron core column, said first positioning segment being wound around the one said positioning space at an outer side of said first iron core column, said second positioning segment being wound around the one said positioning space at an outer side of said third iron core column.

4. The magnetic bead-based filter device as claimed in claim 1, further comprising a conductive glue bonded in between two opposite ends of said enameled wire and said iron core to affix said enameled wire to said iron core.

5. The magnetic bead-based filter device as claimed in claim 3, further comprising a conductive glue bonded in between two opposite ends of said enameled wire and said iron core to affix said enameled wire to said iron core.
